(19) United States
(12) Patent Application Publication
(10) Pub. No.: US 2005/0194726 A1
(43) Pub. Date: Sep. 8, 2005

(54) Air spring

(76) Inventors: Christopher Klatt, Heidelberg (DE); Jurgen Berg, Barsbuttel (DE)

Correspondence Address: HARNESS, DICKEY & PIERCE, P.L.C., P.O. BOX 828, BLOOMFIELD HILLS, MI, 48303, US

(21) Appl. No.: 11/006,489

(22) Filed: Dec. 7, 2004

(30) Foreign Application Priority Data
Dec. 12, 2003 (DE) 103 58 792.6-12

(51) Int. Cl. F16F 9/04

(52) U.S. Cl. 267/64.24

(57) ABSTRACT

An air spring comprising a rolling piston, a bellows with a rolling fold which can be rolled on the wall of the rolling piston, and at least one flat sensor element that can be actuated by the rolling movement of the bellows, and that generates a height-dependent signal. The sensor element is integrated into the wall of the rolling piston or is disposed on the side of the wall that faces the hollow space of the rolling piston.

### CROSS-REFERENCE TO RELATED APPLICATIONS

This application claims the benefit of German Patent Application 103 58 792.6-12, filed Dec. 12, 2003. The disclosure of the above application is incorporated herein by reference.

### FIELD OF THE INVENTION

The invention relates to an air spring comprising a rolling piston, a bellows with a rolling fold that can be rolled on the wall of the rolling piston, and at least one flat sensor element that can be actuated by the rolling movement of the bellows, and which generates a height-dependent signal.

### DESCRIPTION OF THE RELATED ART

Air springs are known from, for example, DE 101 30 507 A1. The prior-art air spring is used for axle suspension in motor vehicles. In essence, the air spring consists of a rolling piston and a bellows that rolls on the rolling piston. For a motor vehicle suspension with air springs, height control is needed to ensure a constant height of the motor vehicle. This height control can be accomplished by using sensors integrated into the air spring. The sensors are disposed on the outer side of the rolling piston and they determine the immersion depth of the bellows. Because it is disposed in the region of the motor vehicle axle, the air spring may be exposed to strong mechanical influences such as, for example, stone impacts. The sensors are protected from mechanical influences, however, by being embedded in an elastomeric covering disposed on the outer periphery of the rolling piston.

### SUMMARY OF THE INVENTION

The object of the present invention is to further develop the prior-art air spring so that it can be fabricated in an inexpensive and simple fashion, and so that it can be better protected from external influences.

To reach the above objective, the sensor element is integrated into the wall of the rolling piston, or it is disposed on the side of the wall facing the hollow space of the rolling piston.

By being integrated into the wall of the rolling piston, the sensor element is protected from external influences such as stone impacts and moisture. Because the sensor element is integrated into the wall of the rolling piston, or is disposed on the side of the wall facing the hollow space, protection of the sensor element is directly provided by the rolling piston which is highly resistant to mechanical influences. A separately applied protection is not needed, and the sensor element is arranged in wear-free and maintenance-free fashion. As a result of being integrated into the rolling piston, the air spring is of simple construction with only a few parts. As such, the number of fabrication steps to fabricate the air spring is reduced, and the air spring can be produced economically. The disposition of the sensor element on the side of the rolling piston that faces the hollow space is particularly inexpensive. Further, the placement of the sensor element within the wall provides unusually good protection of the sensor element from damage.

The rolling piston can be made by injection molding. Injection-molded parts are simple and can be produced in economic fashion. The raw material is also inexpensive. By using injection molding, complicated shapes are possible. In the case of a rolling piston made by injection-molding, integration of the sensor element is particularly simple.

In another embodiment, the rolling piston can be made of aluminum. Aluminum is a very light-weight and stable material that can be processed by injection molding. In yet another embodiment, the rolling piston can be made of steel. Because of the high strength of steel, rolling pistons made of steel can have very thin walls.

The sensor element can be molded into the wall material. To this end, the sensor element is disposed in the mold, and during injection molding, is completely enclosed by the plastic material. In this manner, the sensor element is protected from damage and is disposed in the rolling piston in a wear-free and maintenance-free manner.

The wall preferably consists of two parts, and the sensor element preferably resides between the two wall parts. This permits the use of heat-sensitive sensors that cannot be integrated into the rolling piston by plastic injection molding.

The above objective is also reached by use of an air spring in which the sensor element is disposed on the side of the bellows wall that faces the inner air space. In this manner, the sensor element is protected from mechanical damage resulting, for example, from stone impacts or humidity. The sensor element can be fastened on the side of the bellows that faces the inner air space by use of simple and inexpensive means such as, for example, adhesive bonding.

The sensor element disposed on the wall of the bellows can be in the form of a bending-sensitive film. By means of the bending-sensitive film, it is possible to determine the position of the rolling fold of the bellows, and from this, in turn, the immersion depth of the rolling piston.

It is possible to provide several sensor elements distributed on the periphery of the rolling piston or bellows. Each sensor element senses the immersion depth of the rolling piston. As a result of accelerations, slow-downs and the effect of road unevenness, the rolling piston moves not only perpendicular to the bellows, but also undergoes pitching and wobbling movements. By distributing several sensor elements on the periphery of the rolling piston or of the bellows, the pitching and wobbling motion of the rolling piston can be detected.

It is also possible to provide an integrated circuit which, from the signals of the individual sensor elements, will determine an average immersion depth of the rolling piston. From the pitching and wobbling movements, it is possible by means of the integrated circuit to determine the average immersion depth required for constant-level control of the motor vehicle.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows an air spring with a sensor element disposed on the side of the wall of the rolling piston facing the hollow space;

FIG. 2 shows an air spring with a sensor element integrated into the wall of the rolling piston;

FIG. 3 shows an air spring of FIG. 2 with a two-part wall;

FIG. 4 shows an air spring with a sensor element disposed on the side of the bellows facing the inner air space;

FIG. 5 shows a rolling piston with several sensor elements distributed over the periphery; and

FIG. 6 shows a bellows with several sensor elements distributed over the periphery.

### DETAILED DESCRIPTION OF THE PREFERRED EMBODIMENTS

The following description of the preferred embodiment(s) is merely exemplary in nature and is in no way intended to limit the invention, its application, or uses.

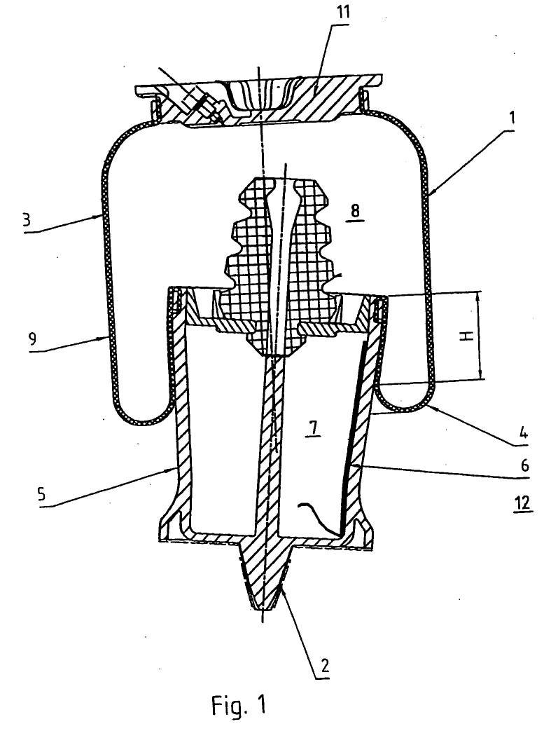

FIG. 1 shows an air spring 1 with a rolling piston 2, an air spring cover 11 disposed at a vertical distance above the rolling piston 2, a bellows 3 with a rolling fold 4 made of an elastomeric material which connects the air spring cover 11 to the rolling piston 2 and, by forming an inner air space 8 of variable volume, can be rolled on the wall 5 or the rolling piston 2.

Rolling piston 2 is preferably made of injection-molded plastic. Alternatively, the rolling piston 2 can also be made of aluminum or steel. On the side of the wall 5 that faces the hollow space 7 of the rolling piston 2 there is disposed a sensor element 6 for sensing the height of the air spring 1. Sensor element 6 consists of an extension-sensitive film that senses strain changes in the wall 5 that result from the rolling movement of the bellows 3 on the wall 5. In particular, the sensor element 6 senses the elongation distribution of the rolling piston 2 in the vertical direction. The hollow space 7 of the rolling piston 2 is hydraulically connected with the inner air space 8 so that the pressure in the hollow space 7 is the same as in the inner air space 8. Because of the lack of a pressure difference, the region of the wall 5 that is covered by the bellows 3 is strain-free. In the region of the wall 5 not covered by the bellows 3, the pressure difference between the hollow space 5 and the surroundings 12 causes a strain in the wall 5 which is sensed by the sensor element 6. The extent to which the bellows 3 is covered corresponds to an immersion depth H. A change in height brings about a specific change in the elongation maximum and elongation distribution in the vertical direction in the wall of rolling piston 2 which is sensed by the sensor element 6. To this end, the sensor element 6 can be divided into several segments. Because the sensor element 6 has a high gain factor, it senses even small strain changes in the wall 5. Based on the measured immersion depth H, the height of the air spring 1 is adjusted. By height control of all axles having an air spring suspension, the height level control of a motor vehicle is made possible.

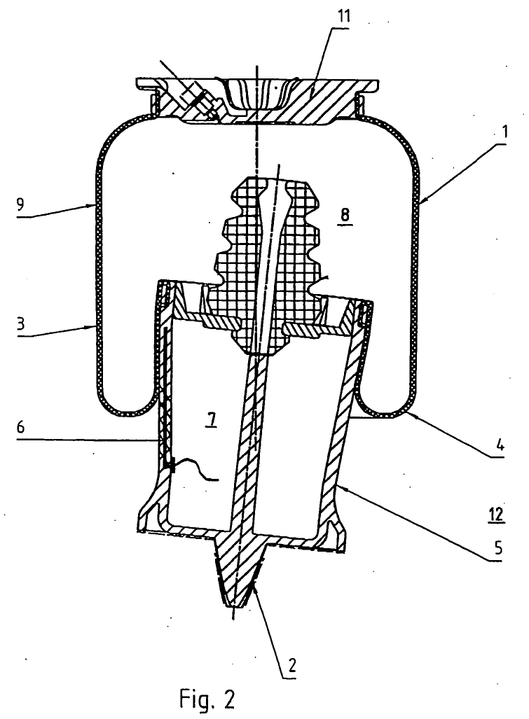

FIG. 2 shows an air spring 1 having a structure as in FIG. 1. Unlike FIG. 1, however, the sensor element 6 is integrated into the wall 5 of the rolling piston 2. The rolling piston 2 is made of an injection-molded plastic material. In the course of the fabrication of the rolling piston 2, the sensor element 6 is placed in an injection mold and the plastic is injection-molded around it. In this manner, the sensor element 6 is completely enclosed by the plastic material and is encapsulated relative to the surroundings 12 and the hollow space 7. As a result of a direct connection, contact of the sensor element 6 with the wall 5 is ensured at all times in a maintenance-free and wear-free manner. As in the embodiment described with reference to FIG. 1, the sensor element 6 consists of a pressure-sensitive film and senses the strain changes in the wall 5 that result from the rolling movement of the bellows 3 on the wall 5.

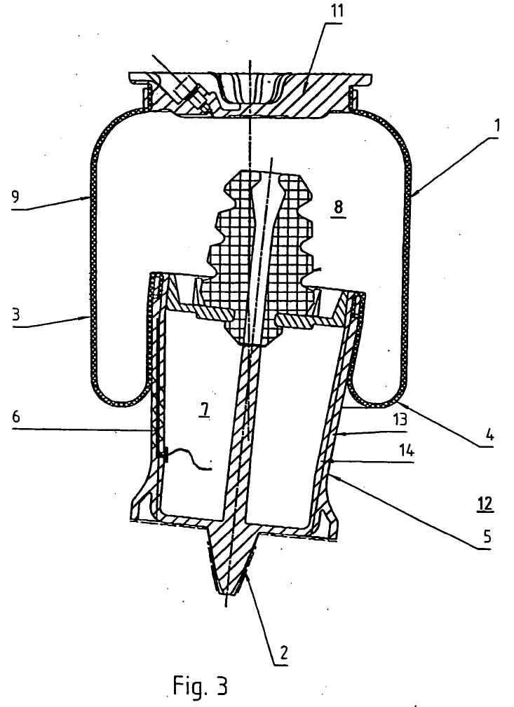

FIG. 3 shows an air spring as in FIG. 2. In this embodiment, however, the wall 5 consists of two parts. Namely, the wall 5 is formed by two wall parts 13 and 14. The sensor element 6 is disposed between the two wall parts 13 and 14.

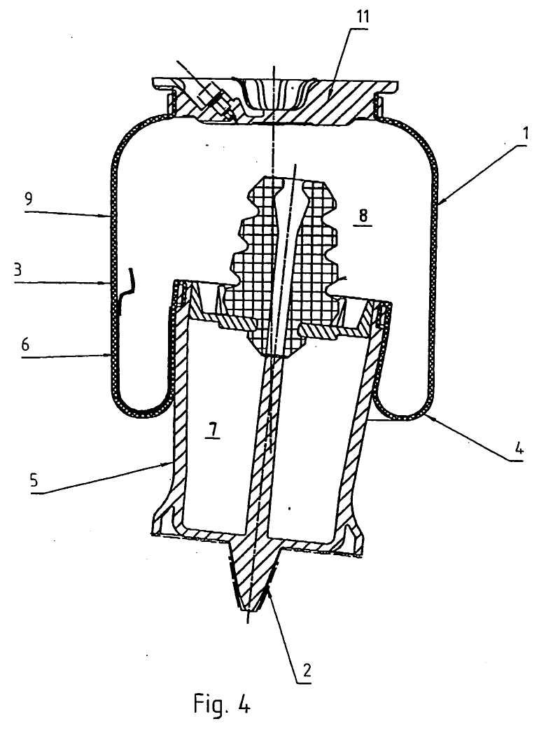

FIG. 4 shows an air spring 1 consisting of a rolling piston 2 made of an injection-molded plastic material, an air spring cover 11 disposed at a vertical distance above the rolling piston 2, a bellows 3 with a rolling fold 4 made of an elastomeric material which connects the air spring cover 11 with the rolling piston 2 and can be rolled on the wall 5 of the rolling piston 2 with formation of an inner air space 8 of variable volume. The sensor element 6 is fastened by adhesive bonding to the side of the wall 9 of the bellows 3 that faces the inner air space 8. The sensor element 6 consists of a bending-sensitive film. The sensor element 6 senses the position of the rolling fold 4 on the bellows 3, or the elongations of the rolling piston 2 caused thereby. This provides a measure of the immersion depth H of the rolling piston 2. Based on the measure of the immersion depth H, the height of the air spring 1 is adjusted. Height control of all axles provided with suspension based on an air spring 1 makes possible the height control of a motor vehicle.

Besides the vertical immersion movement, the rolling piston 2 is also subjected to pitching and wobbling movements about a rotation axis within the rolling piston 2. The pitching and wobbling movements are generated by accelerations and slow-downs, and by the shaking of the air spring 1. If only one sensor element 6 were provided, these pitching and wobbling movements would lead to an erroneous measuring result. With several sensor elements 6 distributed on the periphery, however, an average immersion depth can be determined and the pitching and wobbling movements thus eliminated.

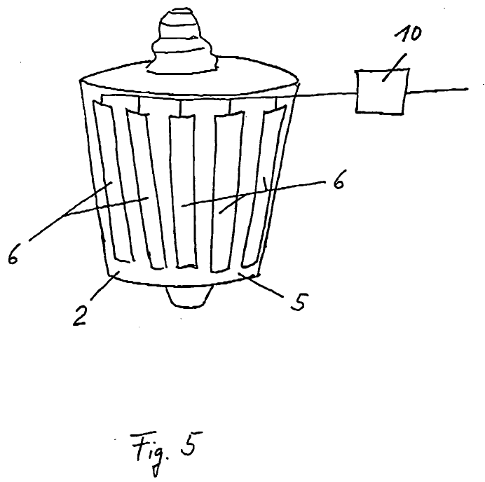

FIG. 5 shows a rolling piston 2 with several sensor elements 6 distributed on the periphery of the rolling piston 2. The sensor elements 6 can be integrated into the wall 5, or they can be fastened to the inner side of the wall 5. The sensor elements 6 consist of pressure-sensitive films and they can also be vertically subdivided. The sensor elements 6 are connected to an integrated circuit. Each sensor element 6 senses one immersion depth. The data measured by the individual sensor elements 6 are transmitted to an integrated circuit 10 where the average immersion depth of the rolling piston 2 is calculated from the individual measured values.

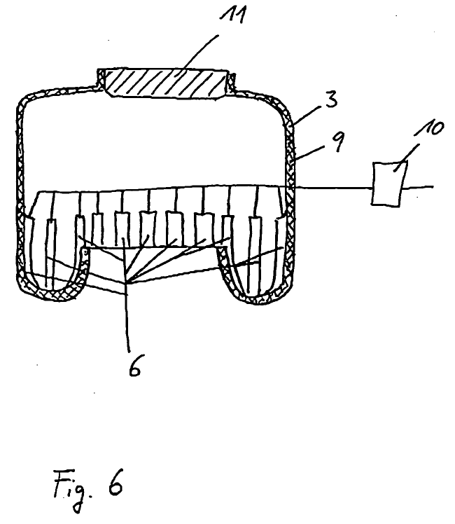

FIG. 6 shows a bellows 3 with an air spring cover 11 and with several sensor elements 6 distributed on the periphery of the bellows 3. The sensor elements 6 are applied by adhesion to the side of the wall 9 that faces the inner air space 8. The sensor elements 6 consist of bending-sensitive films. The sensor elements 6 are connected to the integrated circuit 10. Each sensor element 6 senses one immersion depth. The data measured by the individual sensor elements 6 are transmitted to the integrated circuit 10 where the average immersion depth of the rolling piston 2 is calculated from the individual measured values.

The description of the invention is merely exemplary in nature and, thus, variations that do not depart from the gist of the invention are intended to be within the scope of the invention. Such variations are not to be regarded as a departure from the spirit and scope of the invention.

1. An air spring comprising:
a rolling piston including a wall that defines a hollow space;
a bellows with a rolling fold which can be rolled on the wall of the rolling piston; and
at least one flat sensor element that can be actuated by a rolling movement of the bellows, said sensor element generating a height-dependent signal;
wherein the sensor element is integrated into the wall of the rolling piston or is disposed on a side of the wall that faces the hollow space of the rolling piston.

2. The air spring according to claim 1, wherein the rolling piston is injection-molded from at least one of a plastic material, aluminum, and steel.

3. The air spring according to claim 2, wherein the sensor element is enclosed by an injection-molded material of the wall.

4. The air spring according to claim 1, wherein the wall consists of two parts, and the sensor element is disposed between the two parts.

5. An air spring comprising:
a rolling piston including an outer wall;
a bellows including a wall that defines an inner air space, the wall including a rolling fold which can be rolled on the outer wall of the rolling piston; and
at least one flat sensor element that is actuated by rolling movement of the bellows, the sensor element generating a height-dependent signal;
wherein the sensor element is disposed on a side of the wall of the bellows that faces the inner air space.

6. The air spring according to claim 5, wherein the sensor element comprises a bending-sensitive film.

7. The air spring according to claim 1, wherein a plurality of sensor elements are distributed over a periphery of the rolling piston or of the bellows.

8. The air spring according to claim 7, further comprising:
an integrated circuit which determines an average immersion depth of the rolling piston from signals generated by the plurality of sensor elements.

9. The air spring according to claim 1, wherein the sensor element comprises a bending-sensitive film.

10. The air spring according to 5, wherein a plurality of sensor elements are distributed over a periphery of the rolling piston or of the bellows.

11. The air spring according to claim 10, further comprising:
an integrated circuit which determines an average immersion depth of the rolling piston from signals generated by the plurality of sensor elements.
